(19) United States
(12) Patent Application Publication
(10) Pub. No.: US 2008/0234912 A1
(43) Pub. Date: Sep. 25, 2008

(54) Vehicle Roll Mitigation Through Wheel Slip Controls

(76) Inventor: S. Ben Choi, Daejeon (KR)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 11/661,254

(22) PCT Filed: Aug. 22, 2005
(86) PCT No.: PCT/US05/29912

§ 371 Date: May 15, 2008

Related U.S. Application Data
(60) Provisional application No. 60/604,776, filed on Aug. 26, 2004.

(51) Int. Cl. B60T 8/1755

(52) U.S. Cl. 701/83

(57) ABSTRACT

A method is provided for counteracting a roll moment in a vehicle rollover event. A potential occurrence of the rollover event is detected over an outside wheel. The potential rollover occurrence event is detected when a tire lateral force is greater than a lateral acceleration force. A braking torque is applied to at least one outside wheel (rear outside, front outside or both outside wheels) for producing a longitudinal wheel slip on the at least one outside wheel wherein the longitudinal wheel slip increases a longitudinal force acting on the at least one outside wheel, cooperatively producing a vehicle yaw for off setting an oversteering condition. The peak lateral friction is reduced between a tire coupled to the at least one outside wheel and an underlying road surface in order to reduce the peak lateral friction and the roll moment.

### CROSS REFERENCE TO RELATED APPLICATIONS

This application claims benefit to U.S. Provisional Application Ser. No. 60/604,776, filed Aug. 26, 2004, the disclosure of which is incorporated herein by reference.

### STATEMENT REGARDING FEDERALLY SPONSORED RESEARCH

Not Applicable.

### BACKGROUND OF THE INVENTION

1. Field of the Invention

The present invention relates in general to a method for providing a corrective action to reduce an actual rollover, and more specifically, for a method of applying brake controls to reduce an actual rollover without altering the vehicle trajectory.

2. Description of the Related Art

A vehicle typically becomes unstable (over steered) before it starts to roll over. Dynamic stability control systems are utilized in vehicles to prevent the roll over by reducing the tendency of the over steering. Known methods attempt to prevent a vehicle rollover event from occurring by reducing the speed of the vehicle through braking and/or modifying the vehicle trajectory. While changing the vehicle trajectory may mitigate a potential vehicle rollover event, such trajectory changes may be an undesirable control due to surrounding conditions (e.g., obstacles). With respect to vehicle braking, applying all vehicle brakes in an anti-lock brake mode will reduce the vehicle speed and counteract the potential vehicle rollover event, but it may also result in undesirable vehicle trajectory changes.

### SUMMARY OF THE INVENTION

The present invention has the advantage of reducing the roll moment in a rollover event by producing a longitudinal slip on an outside wheel through vehicle braking control.

In one aspect of the invention, a method is provided for counteracting a roll moment in a vehicle rollover event. A potential occurrence of the rollover event is detected over an outside wheel. The potential rollover occurrence event is detected when a tire lateral force is greater than a lateral acceleration force. A braking torque is applied to at least one outside wheel for producing a longitudinal wheel slip on the at least one outside wheel wherein the longitudinal wheel slip increases a longitudinal force acting on the at least one outside wheel. The peak lateral friction is reduced between a tire coupled to the at least one outside wheel and an underlying road surface in order to reduce the peak lateral friction and the roll moment.

### BRIEF DESCRIPTION OF THE DRAWINGS

FIG. 1 illustrates block diagram of a rollover sensing system for determining a rollover event and counteracting an actual rollover.

FIG. 2 illustrates a front view of a vehicle which shows a center of gravity sprung mass having a gravitational and lateral force exerted on the vehicle.

FIG. 3 illustrates the front view of the vehicle which shows a moment resulting from a tire longitudinal force.

FIG. 4 illustrates the front view of the vehicle which shows a moment resulting from a tire lateral force.

FIG. 5 is a method for preventing a potential rollover event from occurring according to the present invention

### DETAILED DESCRIPTION OF PREFERRED EMBODIMENTS

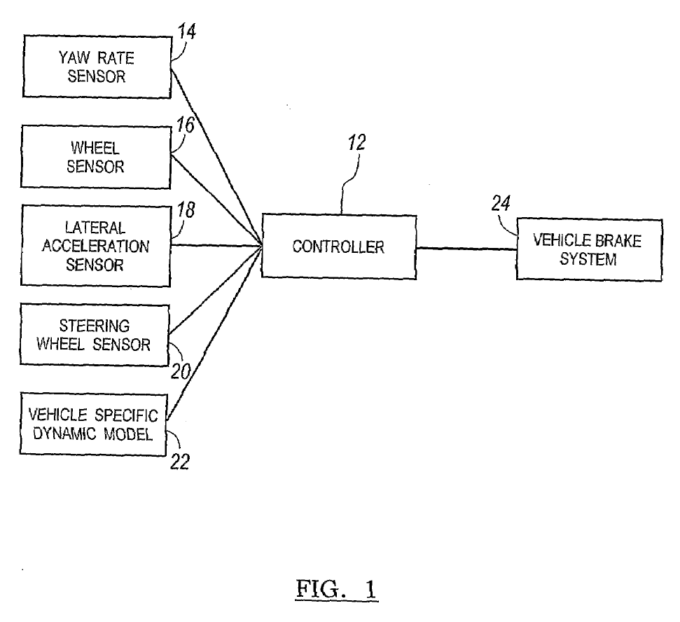

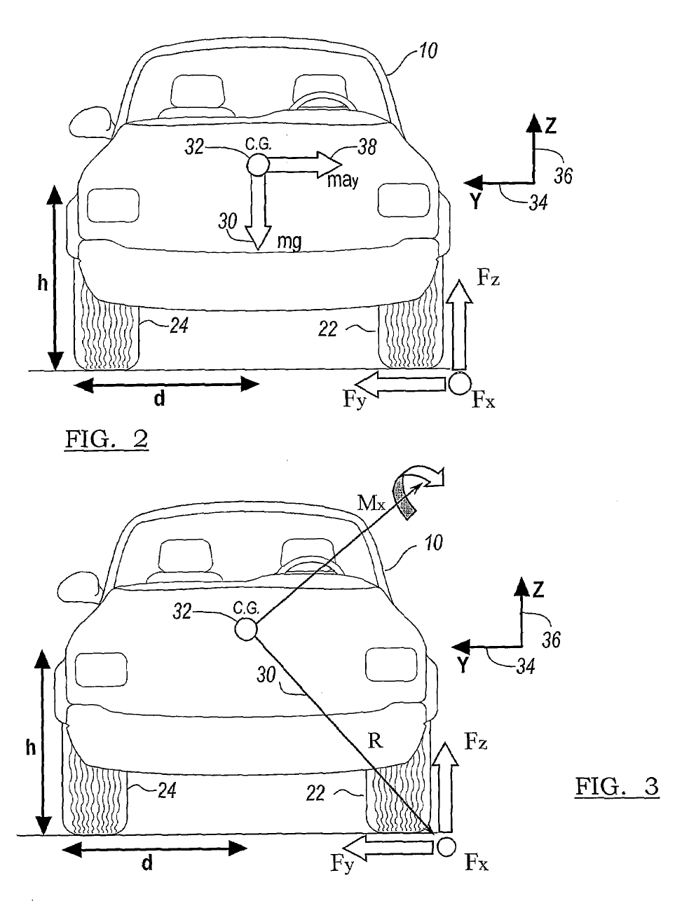

Referring now to the Drawings and particularly to FIG. 1, there is shown a block diagram of a rollover sensing system for determining a rollover event and for providing control actions to mitigate the toll moment for reducing the likelihood of an actual rollover. A controller 12 is coupled to a plurality of sensing devices located throughout a vehicle 10 (shown in FIG. 2) for monitoring vehicle operating parameters. The controller 12 is preferably a microprocessor-based controller. The controller 12 receives signals from the plurality of sensing devices concerning the vehicle operating parameters for determining when the vehicle 10 is in a condition to potentially rollover and to provide a control action to counteract an anticipated rollover event. A plurality of sensors includes a yaw rate sensor 14 for sensing a yaw rate of the vehicle 10, at least one wheel sensor 16 for sensing a speed of the vehicle 10, a lateral acceleration sensor 18 for sensing a lateral acceleration (a_{ym}) 38 of the vehicle 10, and a steering wheel sensor 20 for sensing a steering wheel angle of the vehicle 10. A vehicle specific dynamic model 22 is stored in the controller's memory, or alternatively, in a separate memory storage device for providing specific vehicle characteristics when determining the occurrence of a rollover event and for providing control signals to a vehicle braking system 24 for initiating slip control for actively mitigating a potential rollover condition.

FIG. 2 shows a vehicle 10 influenced by the lateral acceleration a_{ym}. The vehicle 10 has a sprung mass high center of gravity C.G. 32. A y-axis 34 and a z-axis 36 represent directional planes of a vehicle sprung mass C.G. 32 while traveling along a road. The set of axes are fixed to the vehicle spring mass C.G. 32 and rotate with the vehicle spring mass C.G. 32. The vehicle 10 has a lateral acceleration (a_{ym}) 38 that is a vector force exerted by the vehicle 10 along the y-axis 34. The lateral acceleration (a_{ym}) 38 is measured by an accelerometer (not shown) attached to the vehicle sprung mass C.G. 32. The lateral acceleration is based partly on vehicle acceleration and partly on gravity. In other preferred embodiments, alternative methods or devices may be used to determine the lateral acceleration (a_{ym}) 38.

At or near the point of rollover, the normal and lateral forces of the inside tires 24 are negligible. Therefore, it is assumed that the vehicle inertia forces are balanced by the reaction forces of the outside tires 22. The vehicle lateral acceleration force (a_{ym}) 38 (i.e., inertia force) is balanced by the tire lateral force F_{y}. The tire lateral force F_{y} is equal to the product of the friction (of the tire and road surface) and a gravitational force 30 of the vehicle 10 so long as the tire friction remains below a saturation limit that is tolerated by a road surface condition. This is represented by the following formula:

F_{y}=μmg

where μ is tire lateral friction coefficient, m is a vehicle total mass, and g is a gravity constant. The tire lateral friction coefficient μ is a function of tire longitudinal slip as well as tire lateral slip. The saturation limit is reduced when the tire longitudinal slip increases. Tire longitudinal slip occurs for a respective wheel when a sufficiently large braking force is applied to the respective wheel.

In the present invention, braking pressure applied to each respective wheel is independently controlled so that a respective braking force may be applied to a respective wheel independent of the other wheels. This creates a slip condition only on the respective braking wheel for reducing the roll moment in preventing the rollover event.

FIG. 3 illustrates a resulting moment of inertia of a vehicle for a respective tire longitudinal force. The moment of inertia (Mₓ) for an applied tire longitudinal force Fₓ is represented by the following formula:

M=R×Fₓ

where R is a vector connecting the C.G. 32 to the outside tire 22, and Fₓ is the tire longitudinal force. As shown in FIG. 3, the resulting moment Mₓ is on the y-z plane. Since the this moment of inertia Mₓ is perpendicular to the roll axis of the vehicle 10, to the moment of inertia Mₓ has no direct effect on the roll moment of the vehicle 10.

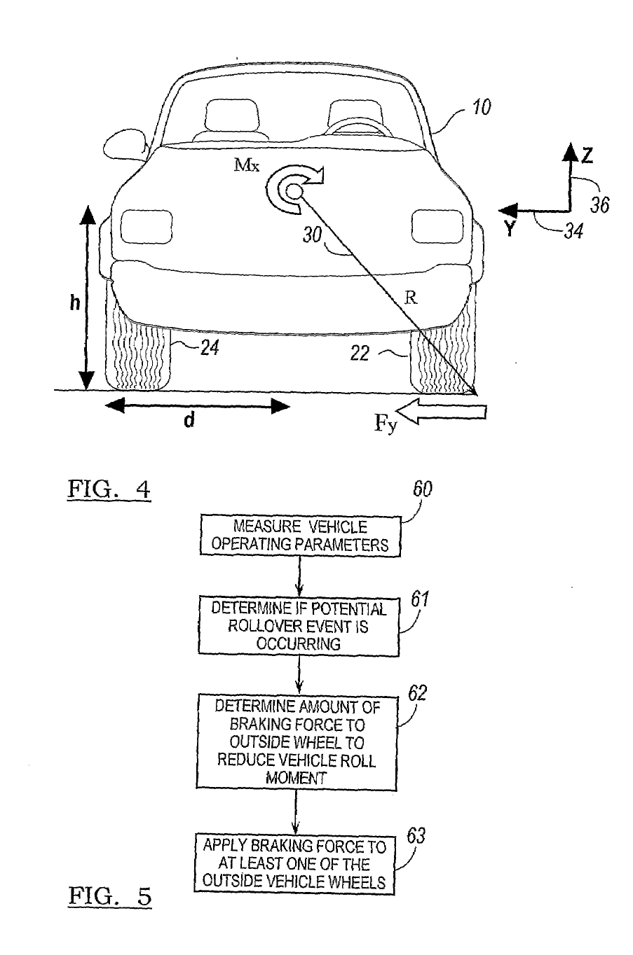

FIG. 4 illustrates the effect the tire lateral force F_{y} has on the vehicle roll moment. When a tire longitudinal force Fₓ is applied to an outside wheel 22, this causes a predetermined amount of wheel slip between the road surface and the tire of wheel 22. As a result, as the tire longitudinal force Fₓ increases, peak lateral friction of the tire of wheel 22 is significantly reduced, and therefore, the lateral force F_{y} is significantly reduced. This mitigates the moment of inertia that may potentially generate the vehicle rollover. This anti-roll moment may be defined by the following formula:

ΔF_{y}*h

where ΔF_{y} is defined as an amount of reduced lateral force associated with the tire longitudinal slip, and h is defined as a nominal C.G. height of the vehicle. The larger the ΔF_{y}, the lower the force of the moment acting upon the vehicle to produce the vehicle rollover.

In a second preferred embodiment, a respective force may be applied only to the rear outside wheel (not shown) or in addition to the braking force applied to the front outside wheel 22. It is known that forces Fₓ and F_{y} induce a moment about the z-axis (i.e., yaw moment) resulting in a potential trajectory change. However by applying braking pressure to the front and rear wheel appropriately, the amount of the induced yaw moment may be minimized. For example, forces Fₓ and ΔF_{y} on the rear outside wheel induces yaw moments whereby the signs of the forces are opposite which results in a negligible yaw moment. Forces Fₓ and ΔF_{y} on the front wheels have a same sign which may result in a significant yaw moment. Although these forces exerted on the front wheels may create a yaw disturbance, such disturbances may potentially correct an oversteering condition that minimizes the overall trajectory effects on the vehicle yaw stability dynamics.

FIG. 5 illustrates a method for counteracting a vehicle roll moment utilizing vehicle braking without affecting the vehicle trajectory. In step 60, various vehicle operating conditions are measured by vehicle sensors disposed throughout the vehicle. In step 61, a potential rollover event is detected using the measured input operating condition. In step 62, a determination is made as to the amount of vehicle braking force required to be applied to reduce the vehicle roll moment which is proportional to the tire lateral force. Applying the vehicle brake to at least one of the outside wheels increases the longitudinal slip which in turn significantly reduces the peak lateral friction of the tire and road surface, and therefore the reduces lateral force generating the roll moment. In step 63, the vehicle braking force as determined in step 62 is applied to at least one outside wheel for reducing the vehicle roll moment.

What is claimed is:

1. A method for counteracting a roll moment in a vehicle rollover event, the method comprising the steps of:
detecting a potential occurrence of said rollover event over an outside wheel, said potential rollover occurrence event being detected when a tire lateral force is greater than a lateral acceleration force; and
applying a braking torque to at least one outside wheel for producing a longitudinal wheel slip on said at least one outside wheel wherein said longitudinal wheel slip increases a longitudinal force acting on said at least one outside wheel which reduces a peak lateral friction between a tire coupled to said at least one outside wheel and an underlying road surface in order to reduce said peak lateral friction and said roll moment.

2. The method of claim 1 wherein an increase in braking torque applied to said at least one outside wheel increases said tire longitudinal slip, wherein said increase in tire longitudinal slip reduces said tire lateral forces exerted on said at least one outside wheel for reducing said roll moment of said vehicle rollover occurrence event.

3. The method of claim 1 wherein said step of applying braking torque to said at least one outside wheel includes applying braking torque only to a rear outside vehicle wheel for producing said longitudinal wheel slip.

4. The method of claim 1 wherein said step of applying braking torque to at least one outside wheel includes applying braking torque only to a front outside vehicle wheel for producing said longitudinal wheel slip.

5. The method of claim 1 wherein said step of applying braking torque to at least one outside wheel includes applying braking torque to a front outside vehicle wheel and a rear outside vehicle for producing said longitudinal wheel slip.

6. The method of claim 5 wherein said braking torque applied to said front outside vehicle wheel and said rear outside vehicle wheel cooperatively produces a vehicle yaw for offsetting an oversteering condition.

7. A rollover mitigation system for counteracting a roll moment in a rollover event of a vehicle, the system comprising:
a vehicle braking system including a plurality of vehicle brake actuators for acting upon a plurality of vehicle wheels, each respective brake being independently actuable upon an associated vehicle wheel for applying braking torque to said associated vehicle wheel;
a plurality of sensors for sensing vehicle operating conditions;
a controller for determining a potential rollover event in response to said sensed operating conditions; and
a vehicle specific dynamic model for providing vehicle specific characteristics to said controller;
wherein said controller determines a braking strategy and controls a braking torque applied to one of said outside wheels for producing a longitudinal wheel slip between a tire coupled to said wheel and an underlying road surface for mitigating said roll moment.

8. The rollover mitigation system of claim 7 wherein said braking strategy includes applying said braking torque to one of said outside wheels for increasing a longitudinal force exerted on said outside wheel which reduces a peak lateral friction between said tire and said underlying road surface.

9. The rollover mitigation system of claim 8 wherein said braking torque applied to one of said outside wheels produces a yaw moment for offsetting an oversteering condition.

10. The rollover mitigation system of claim 7 wherein an increase in braking torque applied to said at least one outside wheel increases said tire longitudinal slip, wherein said increase in tire longitudinal slip reduces said tire lateral forces exerted on said at least one outside wheel for reducing said roll moment of said vehicle rollover occurrence event.

11. The rollover mitigation system of claim 7 wherein applying braking torque to said at least one outside wheel includes applying braking torque only to a rear outside vehicle wheel for producing said longitudinal wheel slip.

12. The method of claim 7 wherein applying braking torque to at least one outside wheel includes applying braking torque only to a front outside vehicle wheel for producing said longitudinal wheel slip.

13. The method of claim 7 wherein applying braking torque to at least one outside wheel includes applying braking torque to a front outside vehicle wheel and a rear outside vehicle for producing said longitudinal wheel slip.

14. The method of claim 13 wherein said braking torque applied to said front outside vehicle wheel and said rear outside vehicle wheel cooperatively produces a vehicle yaw for offsetting an oversteering condition.
